(19) United States
(12) Patent Application Publication
(10) Pub. No.: US 2004/0072608 A1
(43) Pub. Date: Apr. 15, 2004

(54) Gaming machine, server and program for plural players

(75) Inventor: Hirobumi Toyoda, Tokyo (JP)

Correspondence Address: ALFRED A. STADNICKI, ANTONELLI, TERRY, STOUT & KRAUS, LLP, SUITE 1800, ARLINGTON, VA, 22209, US

(73) Assignee: ARUZE CO. LTD., TOKYO (JP)

(21) Appl. No.: 10/612,305

(22) Filed: Jul. 3, 2003

(30) Foreign Application Priority Data
Jul. 5, 2002 (JP) 2002-197391

(51) Int. Cl. A63F 13/00

(52) U.S. Cl. 463/17; 463/16

(57) ABSTRACT

The invention provides a gaming machine, a server and program that amplify the sense of thrill by adding a gambling feature to a game. A poker gaming machine (1) determines the odds by changing the order of odds, which are prepared in advance in response to the difficulty in formation of winning combinations, whenever a player performs betting, wherein since no guarantee in securing that the more game media through repeated betting is given, a gambling feature is brought about in the betting itself, and the sense of thrill enjoyed by a player can be amplified. In addition, it becomes possible to obtain the sense of thrill experienced in bluffing among a plurality of players when the gaming machine, server and program are applied to a gaming machine for single player.

### CROSS-REFERENCE TO RELATED APPLICATIONS

This application is based upon and claims the benefit of priority from the prior Japanese Patent Application No. 2002-197391 filed on July 5th in 2002, the entire contents of which are incorporated herein by reference.

This application is related to co-pending U.S. patent applications entitled “Gaming Machine, Server and Program” and “Gaming Machine, Server, and Program for Card Game”, respectively, both applications being filed on even date herewith. The co-pending applications are expressly incorporated herein by reference.

### BACKGROUND OF THE INVENTION

1. Field of the Invention

The present invention relates to a gaming machine, server and program.

2. Related Art

At present, various types of gaming machines have been introduced in game centers. Among these gaming machines, there are some types of gaming machines in which a plurality of winning combinations and the number of disbursements are predetermined. For example, they are a poker gaming machine, a Japanese flower card gaming machine, a mahjong gaming machine, etc., are available as those particularly prevalent. Of these, the poker gaming machine is the most popular throughout the world.

According to one estimate, ther are more than five hundred kinds of poker games. However, at present, the poker game which is most popular in Las Vegas is called “Seven Card Stud.” This is a game in which, at first, two cards are placed in a face down manner, one card is dealt faced up, betting is commenced from this moment, and after a fifth round of betting is completed, five of the seven cards dealt to respective players are selected for a hand. Also, the poker gaming machine that has become most popular is called “Draw Poker.” This is where five cards are dealt, cards among the five cards, which are considered to be unnecessary by a player, are discarded for new cards, and a winning combination after the discarding is used for a hand. In both cases, the poker game is determined by the strength of the winning combination. The winning combinations are one pair, two pair, three of a kind, straight, flush, full house, four of a kind, straight flush, etc. A winning combination which is more difficult to be formed is the stronger combination. A player who forms the strongest winning combination is the winner, In addition, the number of medals disbursed is a quantity that is obtained by multiplying the odds given for respective winning combinations by the number of bets proposed by a player. However, the stronger the winning combination becomes, the higher the odds become. Therefore, there is no case where straight has higher odds than that of a royal straight flush.

However, in a gaming machine in which such a game method is employed, if it is found that a winning combination is weaker as the game proceeds, it is understood that no winning chance is provided. Thus, there is a problem in which the will of playing a game disappears, and the game itself is not interesting.

Further, when a plurality of players play a game, even if there is a possibility that one's own winning combination is weaker than the winning combinations of others, he/she may carry out bluffing or tactics where he/she intentionally raises the odds in which the others drops out of the game. However, if one plays a game, such bluffing cannot be carried out, wherein there is a problem in that the game is short of interest and the sense of thrill.

### SUMMARY OF THE INVENTION

It is therefore an object of the present invention to provide a gaming machine in which elements related to victory and defeat are added in addition to winning combinations of a poker game, and the sense of thrill of a player can be amplified when a game is engaged by one player.

In order to achieve the above-described object, a gaming machine according to the invention allows a player to play a game while enjoying an even higher sense of thrill by adding a gambling feature to the game.

According to the present invention the following may be provided.

(1) A gaming machine with which a combination-making game is performed is provided such that the combination-making game comprises a plurality of winning combinations, wherein a disbursement number is determined for each winning combination. The gaming machine is characterized in paying out as many game media as obtained by multiplying a corresponding disburse number and a bet number a player bet when the corresponding winning combination is formed. The gaming machine comprises: an operating means for allowing the player to conduct an operation to increase the bet number; a detecting means for detecting the operation through said operating means; a disbursement number change means for changing each disbursement number so that an amount order of disbursements by the gaming machine is changed as said detecting means detects the operation; and a determining means for determining each disbursement number for a respective winning combination.

According to the present invention, it becomes possible to construct a gaming machine including an operating means for operating to increase the above-described number of bets by a player; a detecting means for detecting that the above-described operating means has been operated; a changing means for changing the quantity order of the number of disbursements based on the detection result by the above-described operation detecting means; and a determining means for determining the above-described number of disbursement for the respective winning combinations. In the gaming machine with which a plurality of winning combinations are set. The number of disbursements is predetermined for the respective winning combinations. And the number of game media is obtained by multiplying the number of bets, which is the number of game media bet by a player, and the above-described number of disbursements when any one of the above-described winning combinations is formed by the player.

In the gaming machine, a player is able to start or advance a game by betting game media and is able to acquire game media by forming any one or some of a plurality of winning combinations prepared in advance.

In such a gaming machine, in prior arts, it is common that the gaming machine employs such a construction that the more the number of game media bet by a player (hereinafter called “number of bets”) is increased, the more the game media can be obtained in proportion thereto. In a prior art gaming machine, the number of allotments (called “odds”) responding to the difficulty of formation of the above-described plurality of winning combinations is generally determined. Therefore, for example, if a player forms a winning combination which is difficult to be formed, it would become possible to acquire more game media than in a case of formation of a winning combination which is easy to be formed.

In a gaming machine according to the invention, the order of odds prepared in advance in response to the difficulty of formation is changed, whenever a player bets, in order to determine the odds. That is, such a construction may be employed, in which the odds of a winning combination which is easy to be formed become high, and odds of a winning combination which is difficult to be formed become low.

Accordingly, not only is it possible for a player to expect to acquire more game media even in a case of a winning combination which is easy to be formed, but also the sense of thrill can be amplified, wherein since there is no guarantee of acquiring more game media through repeated bets even if a winning combination can be formed, a gambling feature arises in the betting itself,

Further, by applying the construction according to the invention to a gaming machine for single player use, a player of a gaming machine for single player use can experience the sense of thrill that players in a face-to-face gaming machine sense, in which the players enjoy bluffing, by a method of changing the odds at random.

(2) The gaming machine according to (1) is characterized in that said operating means becomes operative when the player loads game media, or for a predetermined number of times or for a predetermined period of time during the combination-making game that is carried out in the gaming machine.

According to the present invention, the gaming machine of (1) may be constructed so that the above-described operating means becomes operative when a player loads the above-described game media or is utilized by a prescribed number of times or in a prescribed period of time in a game of the above-described gaming machine.

Accordingly, a player can increase the number of bets only when these conditions are satisfied, And, since it should be determined within the limit whether or not the number of bets is increased, the speculative passion of the player is boosted, wherein it is expected that enjoyment in playing the game is further increased.

(3) The gaming machine according to (1) or (2) is characterized in that said determining means determines whether increasing, decreasing, or maintaining said each disbursement number for the reap ctive winning combination.

According to the present invention, the gaming machine of (1) or (2) may be constructed so that the above-described number-of-disbursement determining means determines whether the above-described number of disbursements is increased or decreased, or the number of disbursements is maintained.

Accordingly, there is no guarantee that, in a case where a player increases the number of bets, the odds are proportionally increased as in a prior art gaming machine, wherein it is possible to provide a gambling feature to the player in that a winning combination in which the odds are decreased regardless of increasing the number of bets is formed, a winning combination in which no odds change even if the number of bets is increased is formed, and a winning combination in which the odds are radically increased when the number of bets is increased is formed. With the gambling feature, it is expected that a player is engaged in a game while enjoying an even higher sense of thrill in comparison with any prior art gaming machine.

(4) A gaming machine with which a combination-making game is performed is provided. The combination-making game comprises: collecting a predetermined number of dealt elements so as to make at least one of wining combinations with respectively different ranks; and determining win/loss of the combination-making game based on a corresponding rank. The gaming machine comprises; a bet operating means for allowing a player to conduct an operation to bet game media; a drop operating means for allowing the player to drop the combination-making game; an operation detecting means for detecting that said bet operating means or said drop operating means is operated; a disbursement multiplication factor changing means for determining a multiplication factor of disbursement by a lottery independently from the respective rank having previously been allocated to each wining combination as said operation detecting means detects; and a disbursement number determining means for collecting game media bet by a dropped player and determining a disbursement number obtained from a bet number of game media a winning player bet and the multiplication factor of disbursement.

(5) The gaming machine according to (4) is characterized in that the combination-making game is played by a plurality of players including a dealer set by the gaming machine.

(6) The gaming machine according to (4) is characterized in that said gaming machine comprises: a server being composed of said disbursement multiplication factor changing means and said disbursement number determining means; a game terminal being composed of said bet operating means, said drop operating means, and said operation detecting means; and a communications means including a communications line for connecting said server to said game terminal.

(7) A server for controlling a gaming machine with which a combination-making game is performed is provided. The combination-making game comprises a plurality of winning combinations, wherein a disbursement number is determined for each winning combination. The gaming machine is characterized in paying out as many game media as obtained by multiplying a corresponding disburse number and a bet number a player bet when a corresponding winning combination is formed. The server comprises: an operation detecting means for detecting that the player operates to increase said bet number; a disbursement multiplication factor changing means for changing each disbursement number so that an amount order of disbursements by the gaming machine is changed as said operation detecting means detects an operation; and a disbursement number determining means for determining each disbursement number for each winning combination.

According to the present invention, it becomes possible that a server for controlling a gaming machine in which a plurality of winning combinations are set. The number of disbursements is predetermined for the respective winning combinations. And disbursement of game media whose number is obtained by multiplying the number of bets, which is the number of game media bet by a player, by the number of disbursements, maybe carried out by forming the above-described winning combinations so as to include a detecting means for detecting that a player has operated to increase the above-described number of bets; a changing means for changing the quantity order of the number of disbursements based on the detection result by the above-described operation detecting means, and a determining means for determining the above-described respective number of disbursements for the above-described plurality of winning combinations.

In a gaming machine controlled by the server, a player is able to commence or advance a game by betting game media and is able to acquire game media by forming any one or some of a plurality of winning combinations prepared in advance.

In a gaming machine for executing such a game, in prior arts, it is common that the gaming machine employs such a construction that the more the number of game media bet by a player (hereinafter called “number of bets”) is increased, the more the game media can be obtained in proportion thereto. In a prior art gaming machine, the number of allotments (called “odds”) responding to the difficulty of formation of the above-described plurality of winning combinations is generally determined. Therefore, for example, if a player forms a winning combination which is difficult to be formed, it would become possible to acquire more game media than in a case of formation of a winning combination which is easy to be formed.

In a server according to the invention, in the gaming machine, the order of odds prepared in advance in response to the difficulty in formation is varied whenever a player bets in order to determine the odds. That is, such a construction may be employed, in which the odds become higher in a more easily formed winning combination, and to the contrary the odds become lower in a more difficult formed winning combination.

Accordingly, not only is it possible for a player to expect to acquire more game media even in a case of a winning combination which is easy to be formed, but also the sense of thrill can be amplified, wherein since there is no guarantee of acquiring more game media through repeated bets even though a winning combination can be formed, a gambling feature arises in the betting itself.

(8) A program in which a combination-making game is performed is provided. The combination-making game comprises a plurality of winning combinations, wherein a disbursement number is determined for each winning combination. The gaming machine is characterized in paying out as many game media as obtained by multiplying a corresponding disburse number and a bet number a player bet when a corresponding winning combination is formed. The program comprises: detecting that the player operates to increase said bet number; changing each disbursement number so that an amount order of disbursements by the gaming machine is changed as the detecting means detects an operation of the player; and determining each disbursement number for each winning combination.

According to the present invention, the gaming machine in which a plurality of winning combinations are set is provided. The number of disbursements is predetermined for the respective winning combinations, and disbursement of game media whose number is obtained by multiplying the number of bets, which is the number of game media bet by a player, is carried out by the number of disbursements by forming the above-described winning combinations. The step of detecting that a player has operated to increase the above-described number of bets; step of changing the quantity order of the number of disbursements based on the detection result by the operation detecting step; and step of determining the above-described respective number of disbursements for the above-described plurality of winning combinations may be executed.

In a gaming machine carrying out a game using the program, a player is able to commence or advance a game by betting game media and is able to acquire game media by forming any one or some of a plurality of winning combinations prepared in advance.

In such a gaming machine in which a game is carried out by such a method, conventionally, it is common that the gaming machine employs such a construction that the more the number of game media bet by a player (hereinafter called “number of bets”) is increased, the more the game media can be obtained in proportion thereto. In a prior art gaming machine, the number of allotments (called “odds”) responding to the difficulty of formation of the above-described plurality of winning combinations is generally determined. Therefore, for example, if a player forms a winning combination which is difficult to be formed, it would become possible to acquire more game media than in a case of formation a winning combination which is easy to be formed.

In a gaming machine using a program according to the invention, the order of odds prepared in advance in response to the difficulty in formation is varied whenever a player bets in order to determine the odds. That is, such a construction may be employed, in which the odds become higher in a more easily formed winning combination, and to the contrary the odds become lower in a more difficult formed winning combination.

Accordingly, not only is it possible for a player to expect to acquire more game media even in a case of a winning combination which is easy to be formed, but also the sense of thrill can be amplified, wherein since there is no guarantee of acquiring more game media through repeated bets even though a winning combination can be formed, a gambling feature arises in the betting itself.

Further, by applying the program according to the invention to a gaming machine for single player use, a player of a gaming machine for single player use can experience the sense of thrill that players in a face-to-face gaming machine sense, in which the players enjoy bluffing, by a method of changing the odds at random.

[Definition of terms]

A “gaming machine” according to the invention refers to a gaming machine in which winning combinations are set and the number of disbursements is predetermined for the respective winning combinations. In detail, the concept thereof includes a poker gaming machine, Japanese flower card gaming machine, mahjong gaming machine, etc.

Also, the “number of disbursements” refers to the number of game media given to a player as a prize after winning or losing is determined. The number of disbursements differs, depending on the winning combinations.

In addition, “game media” serve as media to execute a game using the above-described gaming machine. In detail, the concept thereof refers to medals and/or coins.

Further, “number of bets” means a number at which a player bets with respect to odds of respective winning combinations.

Further features of the invention, its nature and various advantages will be more apparent from the accompanying drawings and the following detailed description of the invention.

### BRIEF DESCRIPTION OF THE DRAWINGS

FIG. 1 is a schematic elevation view of a poker gaming machine according to the present invention.

FIG. 2 is a block diagram showing the main control circuit of a poker gaming machine according to an embodiment of the present invention.

FIGS. 3A shows a recording method of lottery results in an almost initial stage for changing odds according to the present invention.

FIGS. 3B shows a recording method of lottery results in a rather early stage for changing odds according to the present invention.

FIGS. 3C shows a recording method of lottery results in a late stage for changing odds according to the present invention.

FIG. 4 is a timing chart showing an exchange of instructions between a player and a gaming machine according to the present invention.

FIG. 5 is a flowchart showing a control process executed in a poker gaming machine according to the present invention.

FIG. 6 is a flowchart showing a control process executed in a poker gaming machine according to the present invention.

FIG. 7 is a flowchart showing game procedures in a poker gaming machine according to the present invention.

FIG. 8 is a flowchart showing game procedures in a poker gaming machine according to the present invention.

FIG. 9 is a sketch showing a screen display in a poker gaming machine according to the present invention.

FIG. 10 is a view showing an allotment table, which is displayed on the screen of a poker gaming machine according to the present invention.

FIG. 11 is a view showing an allotment table, which is displayed on the screen of a poker gaming machine according to the present invention,

FIG. 12 is a schematic elevation view of a poker gaming machine while playing according to the present invention.

FIG. 13 is a sketch showing a screen display of a single player of a poker gaming machine according to the present invention.

FIG. 14 is a view showing an allotment table (after variation) displayed on the screen of a poker gaming machine according to the present invention.

FIG. 15 is a flowchart showing game procedures in a second embodiment of a poker gaming machine according to the invention.

FIG. 16 is a perspective view of a poker gaming machine according to the present invention.

FIG. 17 is a timing chart showing an exchange of instructions between a player and a gaming machine according to the present invention.

FIG. 18 is a flowchart showing a control process executed in a poker gaming machine according to the present invention.

FIG. 19 is a flowchart showing game procedures of a third embodiment of a poker gaming machine according to the present invention.

FIG. 20 is a sketch showing a screen display of a poker gaming machine according to the present invention.

FIG. 21 is a diagram illustrating an outline of a case where a server and gaming machines are connected via a network.

### DETAILED DESCRIPTION OF THE INVENTION

### Embodiment 1

Hereinafter, a description is given of embodiments of the invention with reference to the accompanying drawings.

First, a description is given of an embodiment using a gaming machine manufactured to be played by a plurality of players as the first embodiment.

Configuration of Poker Gaming Machine

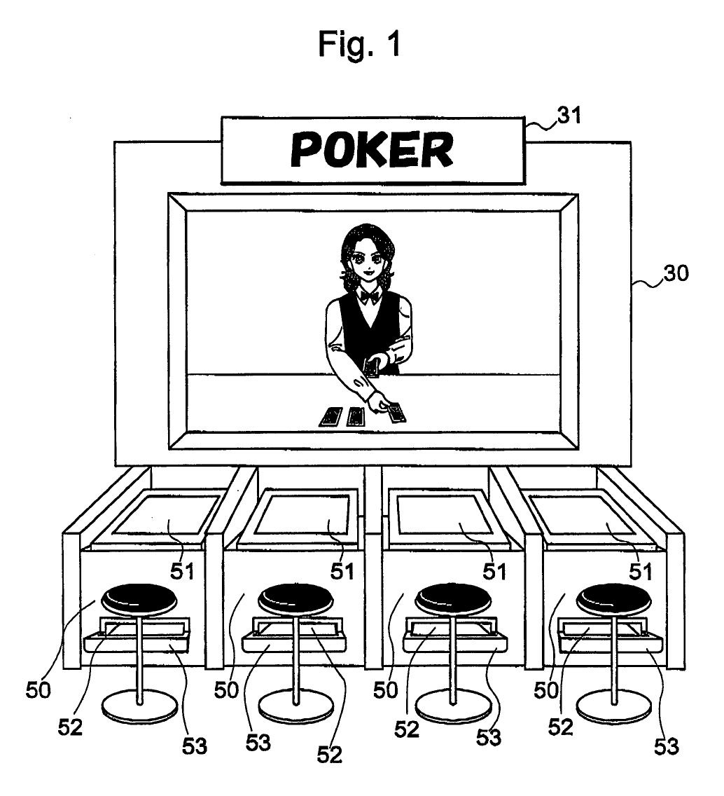

FIG. 1 is a front elevational view showing the overview of a gaming machine according to the invention. Also, in the embodiments described below, a case is shown where the invention is applied to a poker gaming machine as preferred embodiments of a gaming machine according to the invention.

The gaming machine is a machine which a single player or a plurality of players can enjoy, and includes a projector 30, a display panel 31, casings 50, monitor screens 51, medal ejection slots 52, and medal receiving trays 53. A dealer is displayed by the projector 30. The name of a machine, etc., is described on the display panel 31. Hands dealt to a player and an allotment table are displayed on the monitor screen 51. A touch panel (not illustrated) is provided adjacent to the monitor screen 51, which is used for operations carried out by a player.

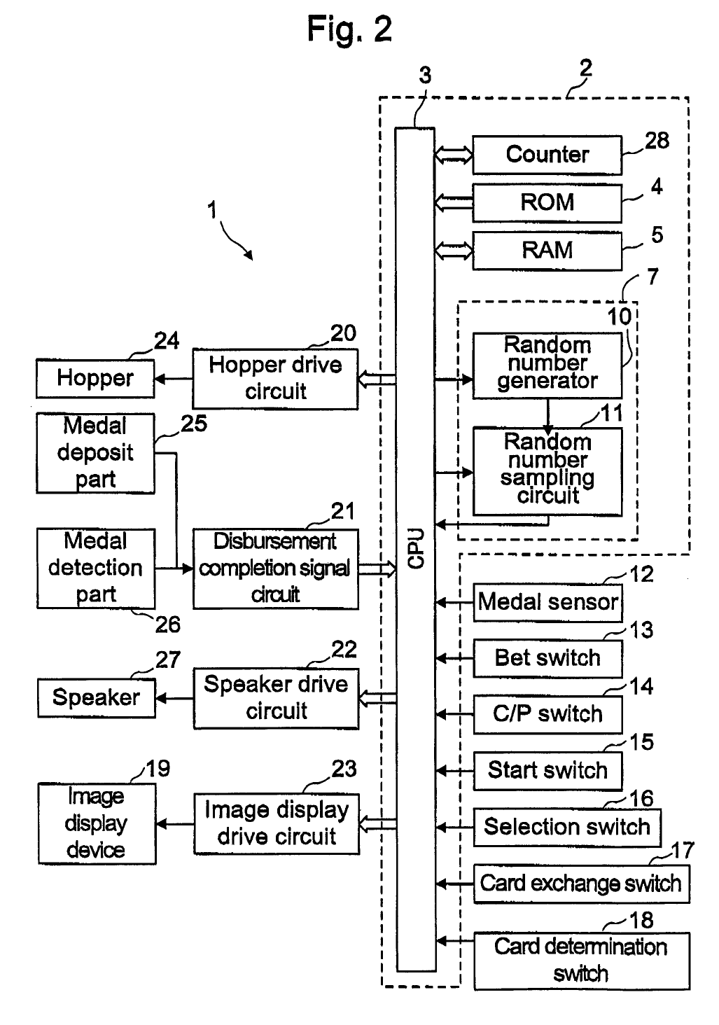

FIG. 2 is a block diagram showing a general construction of a poker gaming machine 1 according to the invention. The poker gaming machine 1 is a machine for playing the so-called Seven Card Stud game. The game in the poker gaming machine 1 is controlled by a game control device 2 which is a game controlling means.

Configuration of the Control Part of Poker Gaming Machine

The game control device 2 is provided with a random number control part 7 for controlling random numbers used in games as shown in FIG. 1.

A process sequence used for games in the poker gaming machine 1 is stored in a ROM 4 as a sequence program, and at the same time, data such as a prize-winning probability table to determine a lottery probability, etc., which controls generation of winning combinations, and a game advancement procedure table, etc., to determine the game advancement procedure are stored therein. Since the CPU 3 operates on the basis of the sequence program, games in the poker gaming machine are controlled.

The above-described random number control part 7 is provided with a random number generator 10 for generating random numbers within a fixed range in accordance with the control of the CPU 3, and a random number sampling circuit 11 for extracting an optional random number from the random numbers generated by the random number generator 10 and transmitting the same to the CPU 3.

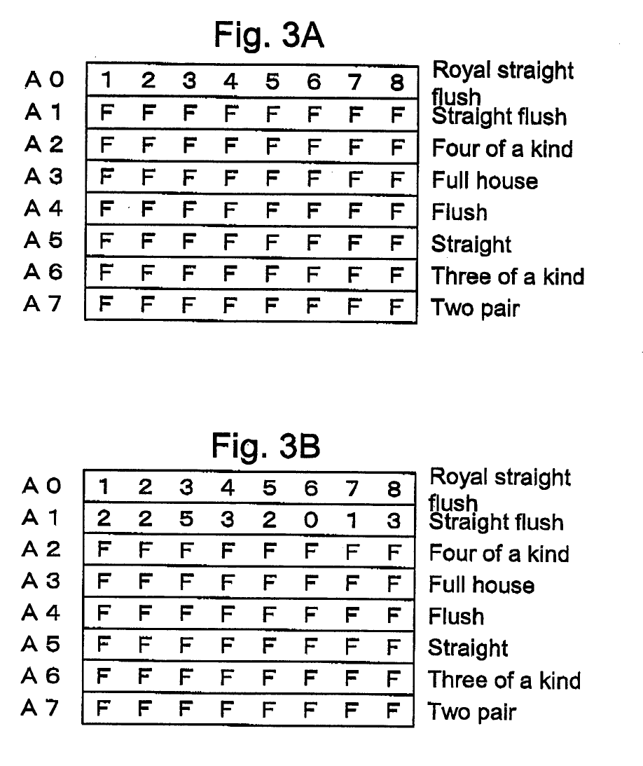

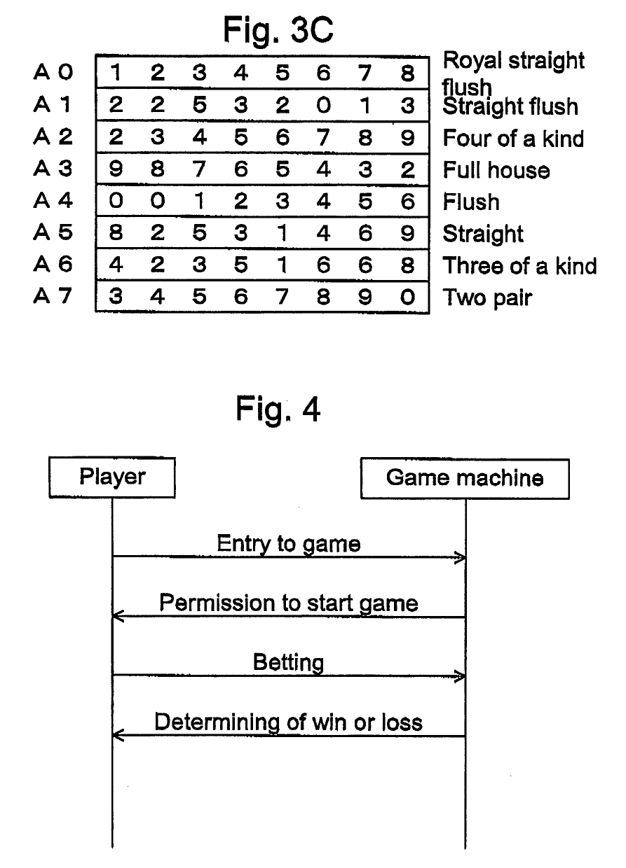

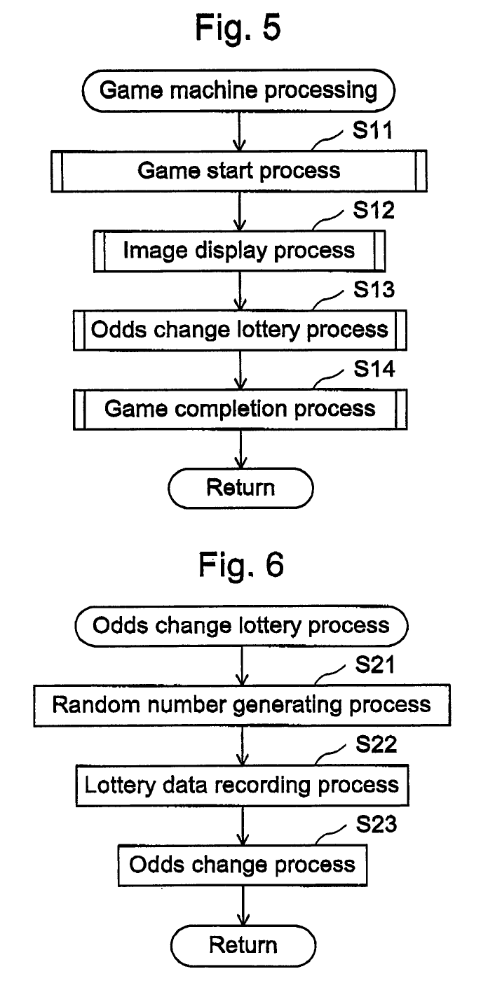

Further, the random numbers emitted from the random number generator 10 are recorded in RAM 5 as data indicating the lottery result. For example, a description is given of a recording process of data indicating the lottery result using a data map as shown in FIGS. 3. FIGS. 3 show the data instructing the lottery result. Respective storage areas of the data are shown in the form of small squares on the screen display.

As shown in FIGS. 3 (A) and 3 (B), data indicating the lottery results are recorded to be symbols A1, A2, A3, A4, A5, A6 and A7 in the RAM 5 in the order from the position of symbol A0 in the drawings. For example, the symbols correspond to winning combinations, for example, Symbol A0 is Royal Flush, Symbol A1 is Straight Flush, etc. In addition, the data indicating the lottery result is composed of, for example, eight digits of numerical values like “01234567.” Numerical values in the respective digits are, respectively, composed of ten numerical values from 0 through 9. Also, “FFFFFFFF” is recorded as empty data in positions when no lottery is carried out yet. When lottery is executed, odds of respective winning combinations are determined on the basis of the lottery result. For example, a number of bets is predetermined, corresponding to numerical values of eight digits, for example, the number of bets is 250 for 12345678, if and is 150 for 22532013.” As shown in FIG. 3(C), when Symbol A0 position through Symbol A7 position are filled with data, that is, the lottery result data of all the winning combinations are recorded therein, the lottery is over.

To a plurality of I/0 ports attached to the above-described CPU 3, a medal sensor 12 for detecting a game medal actually loaded through a medal slot (not illustrated), a bet switch 13 for supplying game medals, which are stored as credit medals, for a game, a C/P switch (credit/pay-out switch) 14 for instructing whether or not game medals given as a winning prize are disbursed or deposited as credits, a start switch 15 for commencing a game, a card exchange switch 17 for instructing an exchange of playing cards dealt to a player, and a card determination switch 18 for executing a game by a combination of the present playing cards are connected. Also, although the respective switches may be constructed of mechanical switches, the switches may be virtual switches that are displayed on an image display device 19 on which game content is displayed, and are operated by a player touching the respective switches displayed on the display.

Further, a hopper drive circuit 20, a disbursement completion signal circuit 21, a speaker drive circuit 22, and an image display drive circuit 23 are connected to the I/O ports.

Hereinafter, a detailed description is given of the above-described respective circuits. A hopper 24 that pays out game medals is connected to the above-described hopper drive circuit 20, wherein the game result of a player indicates a winning against a dealer who is a virtual player, a prescribed number of game medals are disbursed in response to the corresponding result.

A metal deposit part 25 and a medal detection part 26 are connected to the above-described disbursement completion signal circuit 21. The medal deposit part 25 is a part for depositing and storing game medals loaded through a medal slot and game medals disbursed as a winning prize. The medal deposit part 25 is able to deposit and store game medals until the medals reach a prescribed maximum permissible deposit number (for example, 50 medals). Game medals disbursed from the hopper 24 are counted by the medal detection part 26. And, in a disbursement operation of game medals when a winning prize is obtained, if an additional value, which is added and deposited and stored in the medal deposit part 25 or a calculated value in the medal detection part 26 reaches a prescribed disbursement number, a disbursement completion signal is transmitted from the disbursement completion signal circuit 21 to the CPU 3.

The image display device 19 is connected to the above-described image display drive circuit 23, and an image is displayed on the image display device 19 on the basis of control of the CPU 3. A speaker 27 that generates sound effects, etc., is connected to the speaker drive circuit 22, wherein sound effects corresponding to a game status are generated from the speaker 27.

Image Display Device

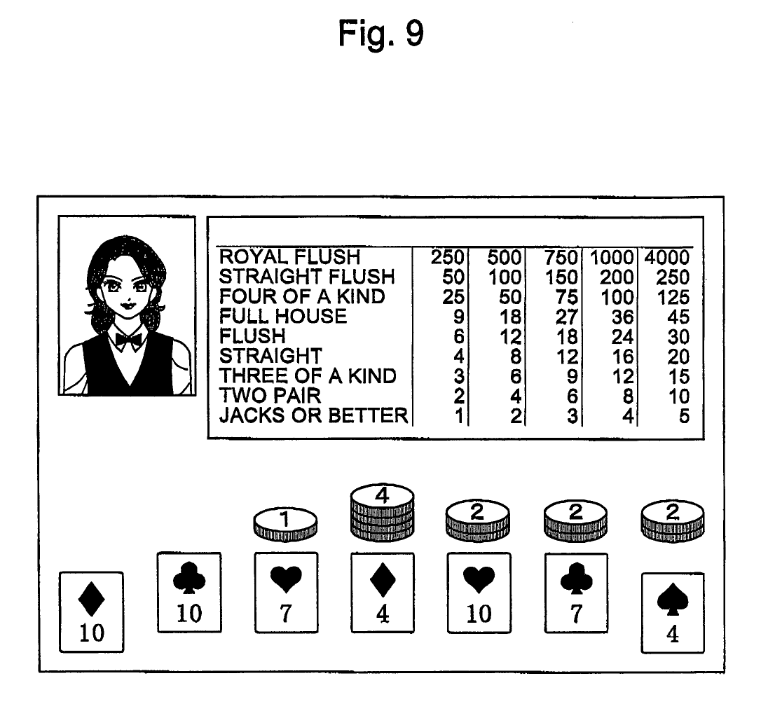

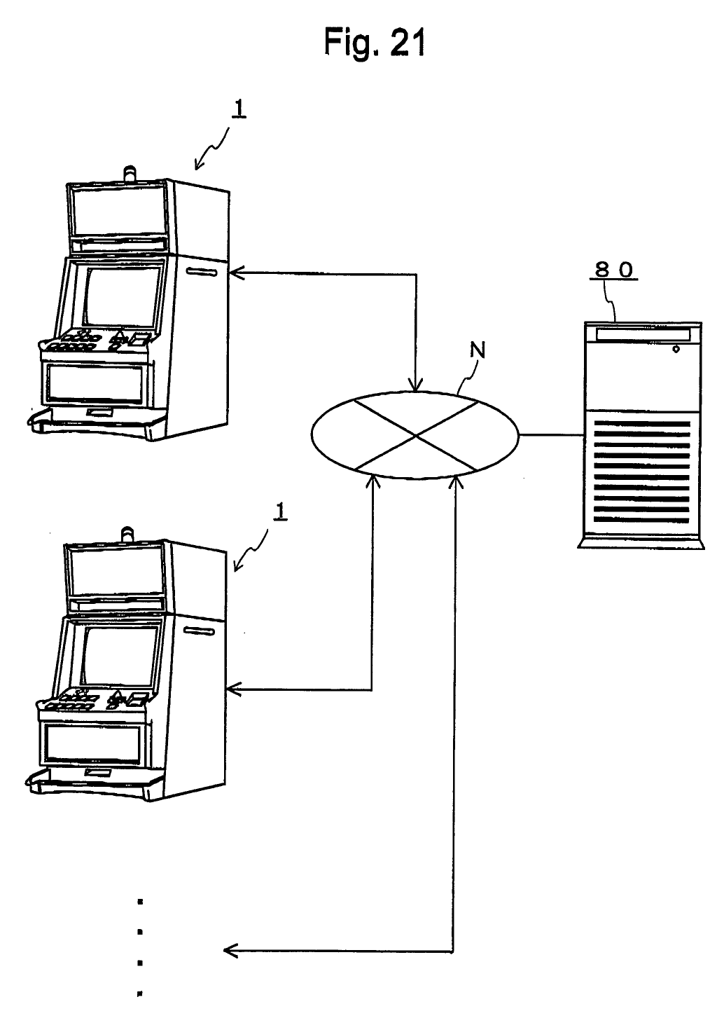

The above-described image display device 19 consists of a CRT display, a liquid crystal display, a plasma display, etc. As shown in FIG. 9 and FIG. 20, the screen thereof displays the progress status of a poker game. For example, in the example shown in FIG. 9, the disbursement ratio for the number of game medals loaded is displayed on the upper half section of the screen, and seven playing cards dealt to a player and the number of bets by the player are displayed on the lower half section of the screen.

Further, in addition to the above-described displaying items, an explanation screen for description of game procedures or virtual switches, etc., for instructing the advancement of a game are displayed on the image display device 19.

Game in Poker Gaming Machine

Next, a description is given of a detailed embodiment of game procedures in the above-described poker gaming machine. Also, as described above, the game advancement procedure storing means composed of the ROM 4, etc., of the game control device 2 stores a plurality of patterns of game advancement procedures based on the strength or advantage of a virtual player, habits of game advancement, and profits obtained by a player, etc. In the respective embodiments, game advancement procedures which are used in a game are extracted from these game advancement procedures.

Timing Chart

FIG. 4 is a timing chart showing an exchange of instructions between the player and the poker gaming machine 1.

First, a player makes an entry into a game. The player inserts a medal into the medal slot as the entry method. When a certain number of medals are loaded, the entry button may be pressed. If the player presses the entry button, the player receives a signal of making an entry.

Next, the poker gaming machine 1 transmits a signal of permitting the game. That is, the CPU 3 starts and creates a status in which the player can execute a game.

Next, the player executes betting, The player carries out betting five times in total to the poker gaming machine 1 in the betting interval. That is, the number of medals bet by the player is transmitted to the poker gaming machine 1.

Finally, the winning or losing is determined. The poker gaming machine 1 determines the winning or losing in accordance with the data stored in the ROM 4. And, the result of the game is transmitted to the player.

Gaming Machine Processing

Next, a description is given of a process executed inside the poker gaming machine. Further, as described above, since the game advancement procedure storing means composed of the ROM 4, etc., of the game control device 2 stores a plurality of patterns of game advancement procedures on the basis of the strength or advantage of a virtual player, habits of game advancement, and profits obtained by a player, etc., in the respective embodiments, game advancement procedures which are used in a game are extracted from these game advancement procedures.

First, as shown in FIG. 4, in the poker gaming machine 1, a game start process is executed (Step S11). In Step S11, the medal sensor 12 detects loaded medals when a player loads medals, and transmits it to the CPU 3 that medals have been loaded, wherein the CPU 3 calls game advancement procedures from the ROM 4, and the poker gaming machine 1 commences a game.

Next, an image display process is executed (Step S12). In the process, the CPU 3 sets image data in a video RAM on the basis of the image display drive circuit 23, and the image data set in the video RAM are displayed on the image display device 19. After the process is terminated, the process shifts to Step S13.

Next, an odds changing lottery process is executed (Step S13). In the process, the CPU 3 causes the random number generator 10 to generate random numbers. Then, the random number sampling circuit 11 extracts an optional random number from the random numbers generated by the random number generator 10 and transmits it to the CPU 3. The CPU 3 records the random number in the RAM 5 as the lottery result. In addition, the process will be described later. After the process is terminated, the process shifts to Step S14.

Next, the game terminating process is executed (Step S14). In the process, the CPU 3 determines the winning or losing in accordance with the game advancement procedures stored in the ROM 4. The CPU 3 sends the hopper drive circuit of the winner an instruction for disbursing a prescribed number of medals, whereby medals are disbursed from the hopper 24. After the process is terminated, the present routine is immediately terminated.

Odds Changing Lottery Process

As described above, a sub routine shown in FIG. 6 is called in the odds changing lottery process routine called in Step S13.

First, a random number generating process is executed (Step S21). In the process, the CPU 3 provides the random number generator 10 with an instruction for generating random numbers. The random number generator 10 that receives the instruction generates random numbers within a prescribed range on the basis of the instruction, and issues a signal indicating the value of a random number to the random number sampling circuit 11.

More specifically, the data indicating the lottery result consists of eight digits of numerical values, for example, “01234567,” and the numerical value of the respective digits consists of ten numerical values from 0 through 9. The random number generator 10 that receives an instruction for generating random numbers from the CPU 3 generates any random number of ten numerical values from 0 through 9 eight times per instruction. After the process is terminated, the process shifts to Step S22.

Next, a lottery data recording process is executed (Step S22). The CPU 3 receives a signal indicating the value of the above-described random number, and records the lottery result in the RAM 5 as the lottery data. That is, the CPU 3 transmits a signal indicating the value of the random number, which is issued from the random number generator 10, to the RAM 5, and as shown in FIG. 3, records the data, in which each of the random numbers consists of eight digits, generated by arranging the respective random numbers in the order of generation, in the RAM 5 as the odds changing lottery result. The RAM 5 is provided with a storage area for recording the data, in which the symbols correspond to winning combinations, for example, Symbol A0 indicates Royal Flush and Symbol A1 indicates Straight Flush. When the lottery is carried out, the lottery results from A0 to A7 are recorded in order. After the process is terminated, the process shifts to Step S23.

Next, an odds changing process is executed (Step S23). The CPU 3 determines the odds of respective winning combinations in accordance with the lottery data recorded in Step S22. Thereby, the odds displayed in the allotment table, which appear on the monitor screen, are varied. In detail, as shown in FIG. 11, there are cases where winning combinations occur in which the odds of a Straight become higher than that of a Royal Flush or the odds are decreased even if the number of bets is increased like Two Pair. After the process is terminated, the present routine is immediately terminated.

By executing the processes in the above-described Steps S21 through S23, since “,with respect to winning combinations included in the above-described plurality of winning combinations, the above-described number-of-disbursement determining means determines whether the above-described number of disbursements is increased or decreased, or the number of disbursements is maintained,” when a player increases the number of bets, no guarantee is secured by which the odds are increased in proportion to an increase in the number of bets by the player as in the conventional gaming machines, wherein such a gambling feature can be carried out to players, that is, a winning combination whose odds are decreased even if the number of bets is increased is formed, a winning combination whose odds do not change at all even if the number of bets is increased is formed, or a winning combination whose odds are radically increased when the number of bets is increased is formed. With the gambling feature, it is expected that a player is engaged in games while experiencing a high sense of thrill in comparison with the conventional gaming machines.

Game Procedure

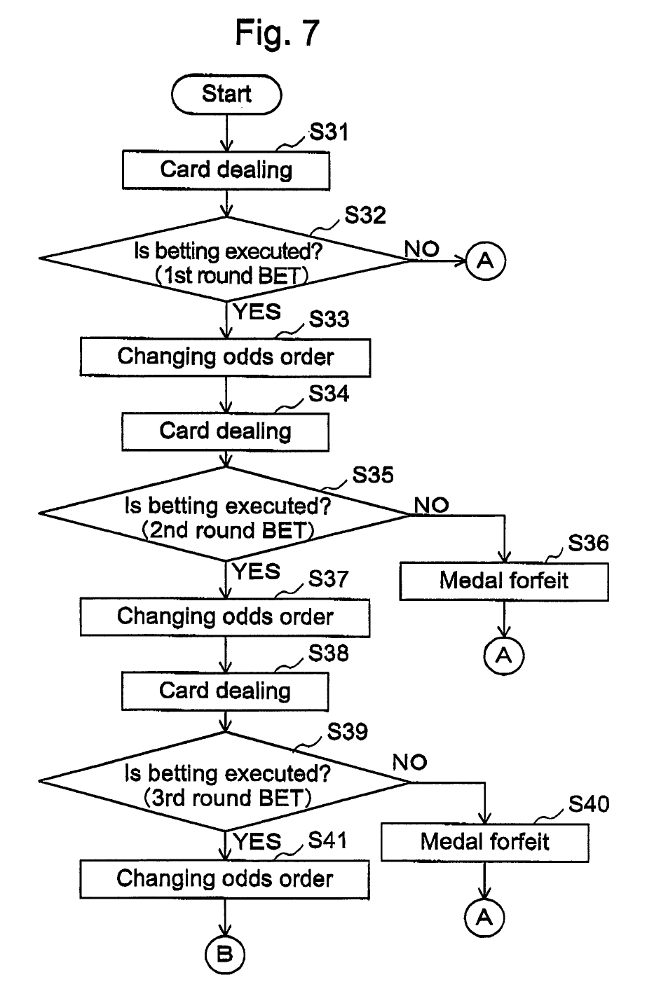

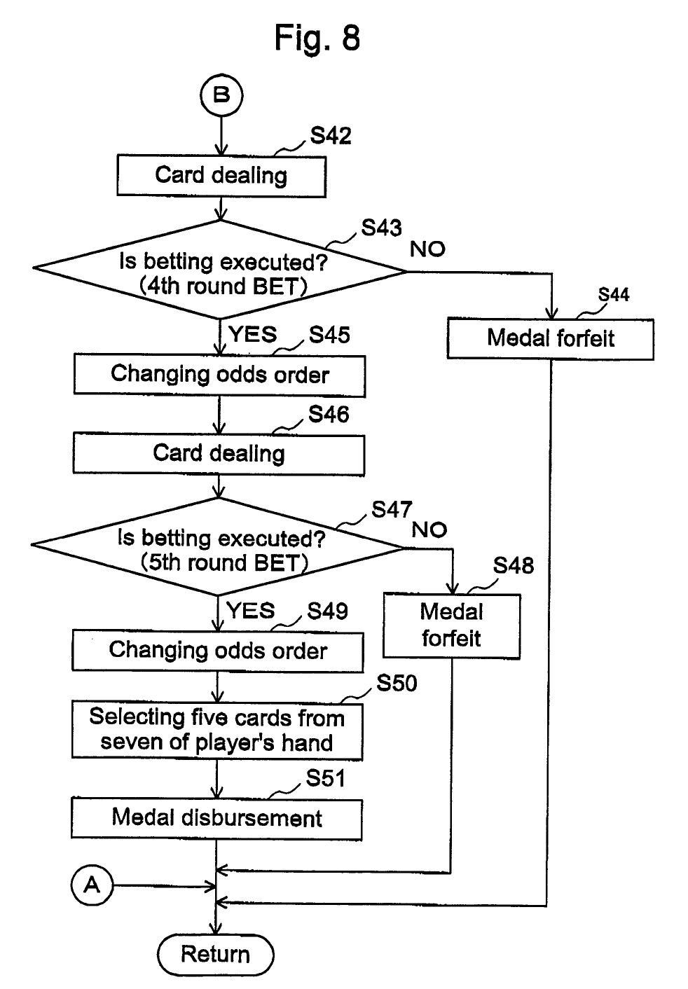

Next, FIG. 7 and FIG. 8 are flowcharts showing the game procedures.

First, cards are dealt (Step S31). The CPU 3 transmits an instruction for determining the kind of cards to the random number generator 10. The random number generator 10 executes a lottery to determine the kind of cards.

The lottery data are composed of, for example, two digits of a numerical value like “23,” and the numerical values per digit are, respectively, composed of ten numerical values from 0 through 9. The random number generator 10 that receives a random number generating instruction from the CPU 3 generates a random number, which becomes either one of numerical values from 0 through 9, two times p r instruction. And, the random number is transmitted to the CPU 3 through the random number sampling circuit 11, and the CPU 3 transmits a signal indicating the numerical value of the random number to the RAM 5, and records data of the respective random numbers in the RAM 5 as card lottery result. The data are displayed by the projector 30 and monitor screen 51 as a card dealt to a player. In addition, the card is displayed on monitor screens other than the player in a face down manner. Therefore, no player other than the player to which the card is dealt knows the content of the card. A second card is dealt to respective players as in the above, and the second card is displayed on the monitor screen other than the player's screen in a face down manner, therefore no player other than the respective player knows the content thereof. A third card is dealt to respective players and are displayed by the projector 30 and monitor screens 51 with the face thereof turned up.

After the third card is dealt, the players determine whether or not each of them executes betting (Step S32). That is, the players determine whether or not each of them executes betting or drops out of the game, on the basis of the cards dealt in Step S31. When it is decided that betting is executed, the process shifts to Step S33, and when a player decides that he/she drops out of the game, the present game is over,

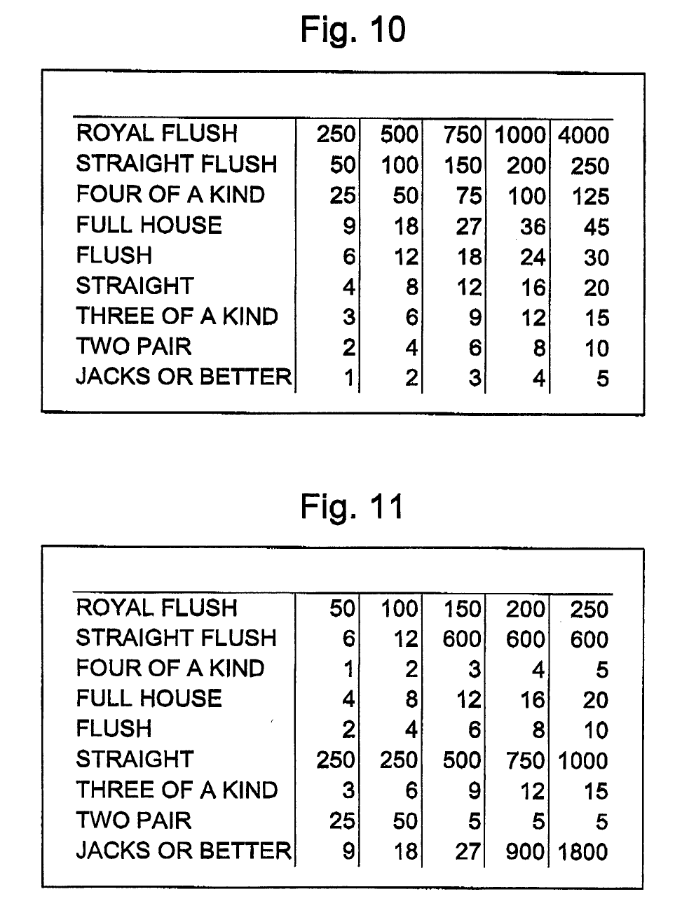

When betting is carried out, the order of odds is varied (Step S33). The CPU 3 receives from a player an instruction about whether or not betting is carried out, and recognizes that the betting interval is expired. And, the CPU 3 carries out a process of changing the order of odds. Herein, as described above, the CPU 3 provides the random number generator 10 with an instruction for generating random numbers. Then, the random number sampling circuit 11 extracts an optional random number from the random numbers generated by the random number generator 10 and transmits it to the CPU 3. And, the CPU 3 records it in the RAM 5 as the data indicating the lottery result. Since, in the data indicating the lottery result, a number of bets corresponding to a numerical value of eight digits is determined, for example, the number of bets is 250 if the numerical value is “12345678” and is 150 if the numerical value is “2253013,” the CPU 3 reads the numerical values of eight digits recorded in the RAM 5, and determines the odds of the respective winning combinations. Then, the odds displayed in the allotment table appearing on the monitor screen 51 vary from a state shown in FIG. 10 to that shown in FIG. 11. In detail, as shown in FIG. 11, winning combinations are brought about, in which the odds of Straight become higher than the odds of Royal Flush, or the odds are decreased, as in Two Pair, even if the number of bets is increased. After the process is terminated, the process shifts to Step S34.

Next, the fourth card is dealt (Step S34). As in Step S31, the CPU 3 transmits an instruction of determining the kind of card to the random number generator 10. The random number generator 10 executes a lottery to determine the kind of card. And, the data of the lottery are displayed by the projector 30 and monitor screens 51 as a card to be dealt to a player.

Next, a player determines whether or not the second betting is executed (Step S35). As in Step S32, a player determines on the basis of the card dealt in Step S34 whether or not the player carries out betting or drops out of the game. When betting is decided, the process shifts to Step S37, and when the player decides that he/she drops-out of the game, the process shifts to Step S36.

When the player decides that he/she drops out of the game, the player is deprived of or has to forfeit medals (Step S40). That is, the medals placed up for bets are not disbursed to the player, and the game is over.

When betting is executed, the order of the odds is varied (Step S37). Herein, as in Step S33, as described above, the CPU 3 causes the random number generator 10 to generate random numbers. Then, the random number sampling circuit 11 extracts an optional random number from the random numbers generated by the random number generator 10 and transmits it to the CPU 3. And, the CPU 3 determines the odds of the respective winning combinations in accordance with the lottery result, and the order of the odds is varied. After the process is terminated, the process shifts to Step S38.

Next, a fifth card is dealt (Step S38). As in Steps S31 and S34, the CPU 3 transmits an instruction of determining the kind of card to the random number generator 10. The random number generator 10 carries out lottery to determine the kind of card. And, the data of the lottery are displayed by the projector 30 and monitor screen 51 as cards dealt to players.

Next, a player determines whether or not the third betting is executed (Step S39). As in Steps S32 and S35, the player decides on the basis of the cards dealt in Step S38 whether or not he/she is engaged in the game or drops out thereof. When the player decides the betting, the process shifts to Step S41, and when the player decides to drop out of the game, the process shifts to Step S40.

When the player decides to drop out of the game, the player is deprived of or has to forfeit the medals (Step S40). That is, the medals placed up for bets are not disbursed to the player, and the game is over.

When the betting proceeds, the order of odds is varied (Step S41). Herein, as in Steps S33 and S37, as described above, the CPU 3 causes the random number generator 10 to generate random numbers. Then, the random number sampling circuit 11 extracts an optional random number from the random numbers generated by the random number generator 10 and transmits it to the CPU 3. And, the CPU 3 determines the odds of the respective winning combinations in accordance with the lottery result, wherein the order of the odds is varied. After the process is terminated, the process shifts to Step S42.

Next, a sixth card is dealt (Step S42). As in Steps S31, S34 and S38, the CPU 3 transmits an instruction of determining the kind of card to the random number generator 10. The random number generator 10 executes a lottery to determine the kind of card. And, the data of the lottery are displayed by the projector 30 and monitor screen 51 as the card to be dealt to the player.

Next, a player determines whether or not the fourth betting is executed (Step S43). As in Steps S32, S35 and S39, the player decides, on the basis of the card dealt in Step S42, whether or not the player executes the betting or drops out of the game. When the betting is decided, the process shifts to Step S45, and when the player decides to drop out thereof, the process shifts to Step S44.

When the player decides to drop out of the game, the player is deprived of or has to forfeit the medals (Step S44). As in Steps S36 and S40, the medals placed up for bets are not disbursed to the player, and the game is over.

When the betting is executed, the order of odds is varied (Step S45). Herein, as in Steps S33, S37 and S41, as described above, the CPU 3 causes the random number generator 10 to generate random numbers. Then, the random number sampling circuit 11 extracts an optional random number from the random numbers generated by the random number generator 10 and transmits it to the CPU 3, wherein the CPU 3 determines the odds of the respective winning combinations in accordance with the lottery result, and the order of the odds is varied. The order of the odds at this moment will become the final order. After the process is terminated, the process shifts to Step S46.

Next, a seventh card is dealt (Step S46). As in Steps S31, S34, S38 and S42, the CPU 3 transmits an instruction of determining the kind of card to the random number generator 10. The random number generator 10 executes a lottery to determine the kind of card. And, the lottery data are displayed by the projector 30 and monitor screen 51 as the card to be dealt to the player. Also, the card is displayed in a face down manner on the monitor screens other than the player's screen.

Next, a player determines whether or not the fifth betting is executed (Step S47). As in Steps S32, S35, S39 and S43, the player decides, on the basis of the card dealt in Step S46, whether or not the player executes the betting or drops out of the game. When betting is decided, the process shifts to Step S49, and when the player decides to drop out thereof, the process shifts to Step S48.

When the player decides to drop out of the game, the player is deprived of or has to forfeit the medals (Step S48). As in Steps S36, S40 and S44, the medals placed up for bets are not disbursed to the player, and the game is over.

When the betting is executed, the order of odds is varied (Step S49). Herein, as in Steps S33, S37, S41 and S45, as described above, the CPU 3 causes the random number generator 10 to generate random numbers. Then, the random number sampling circuit 11 extracts an optional number from the random numbers generated by the random number generator 10 and transmits it to the CPU 3, wherein the CPU 3 determines the odds of the respective winning combinations in accordance with the lottery result, and the order of the odds is varied. The order of the odds at this moment becomes the final order. After the process is terminated, the process shifts to Step S50.

The counter 28 counts the time of the betting interval and informs the CPU 3 of the elapse of a prescribed period of time, When a prescribed period of time in the fifth betting interval elapses in the counter 28, the fifth betting interval ends. The player selects five cards from the seven cards for the game (Step S50). Selection of the five cards may be selected by a player or by a gaming machine.

Next, disbursement of medals is carried out (Step S51). The hopper 24 having the game medals deposited and reserved therein is connected to the hopper drive circuit 20. The CPU 3 judges a final winning combination of the player and multiplies it by the final number of bets corresponding to the winning combination. And, the CPU 3 transmits it to the hopper drive circuit 20. The hopper drive circuit 20 operates on the hopper 24 that disburses some from its reserved game medals.

In addition, in the present embodiment, although the type of poker is “Seven Card Stud”, the invention is not limited thereto. The invention is applicable to other types of poker games by a plurality of persons in addition to “Draw Poker”.

By carrying out the embodiment, a factor of winning and losing does not depend on the difficulty in formation of winning combinations. Therefore, there is a possibility for a player to win even with a lower-ranked winning combination formed, wherein, since winning and losing of a game are not foreseen to the end, a player is able to enjoy a game to the end while tasting the sense of thrill without giving up the game even if the player understands, as the game proceeds, the game that his/her own winning combination is lower-ranked.

Also, when a plurality of players execute a game, there are cases where bluffing or tactics is taken, by which a player intentionally raises the bet or stakes even if a lower-ranked winning combination is about to be formed, and causes hesitation in opposing players. By carrying out the invention, since elements for amplifying the sense of thrill is added in addition to the bluffing, players are able to further enjoy games.

### Embodiment 2

Game procedure

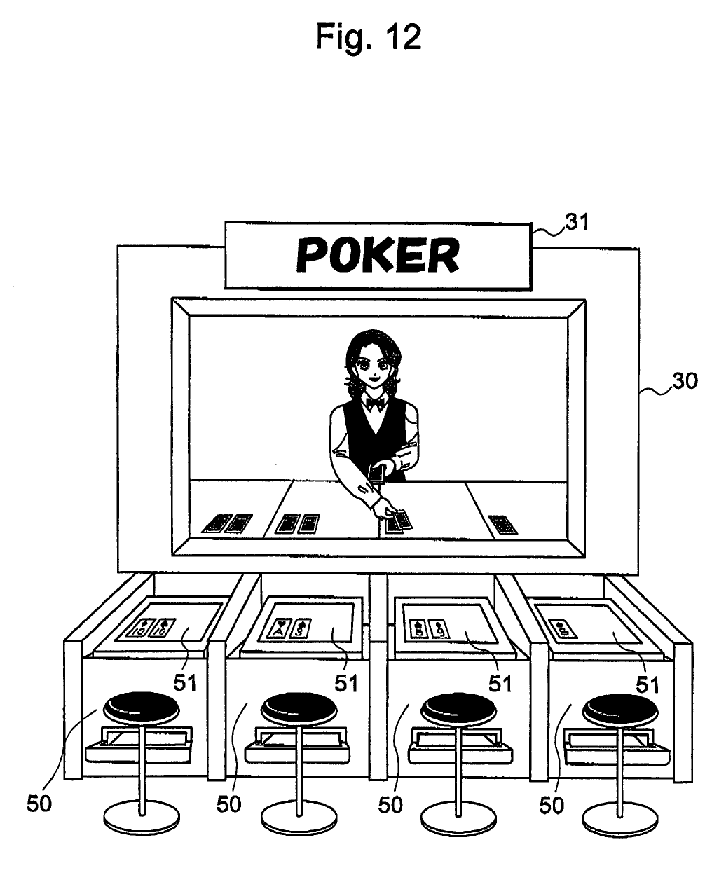

Next, with reference to FIG. 12 through FIG. 15, a description is given of a case where a poker game slightly different from Embodiment 1 is carried out using an apparatus similar to that of Embodiment 1.

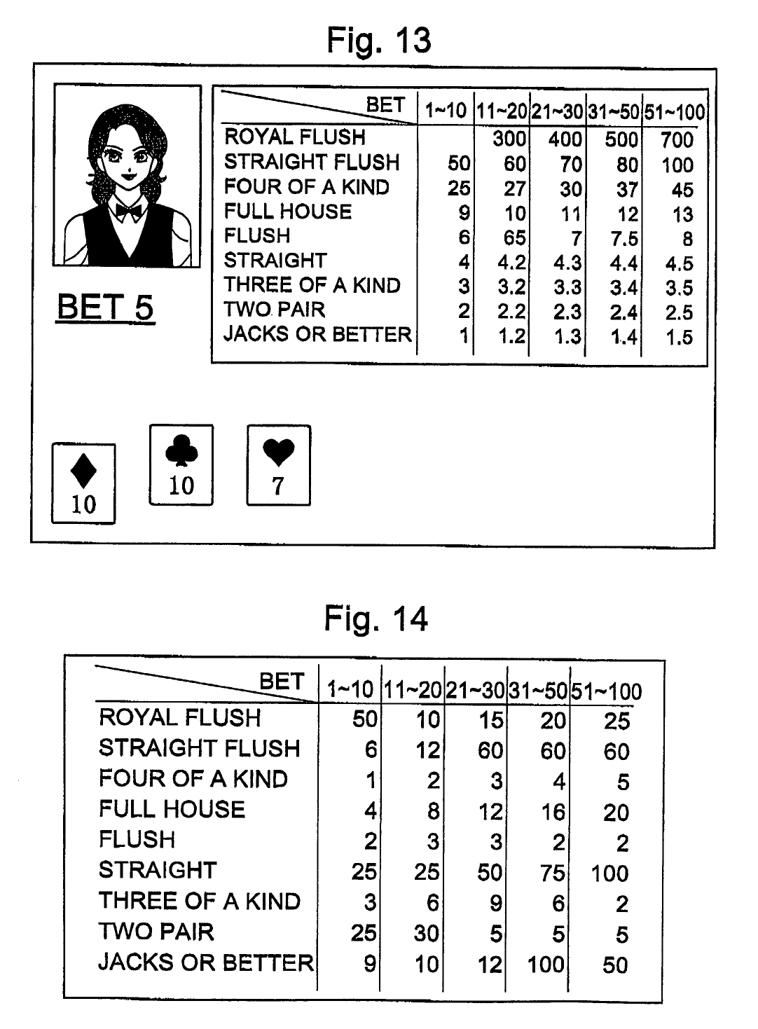

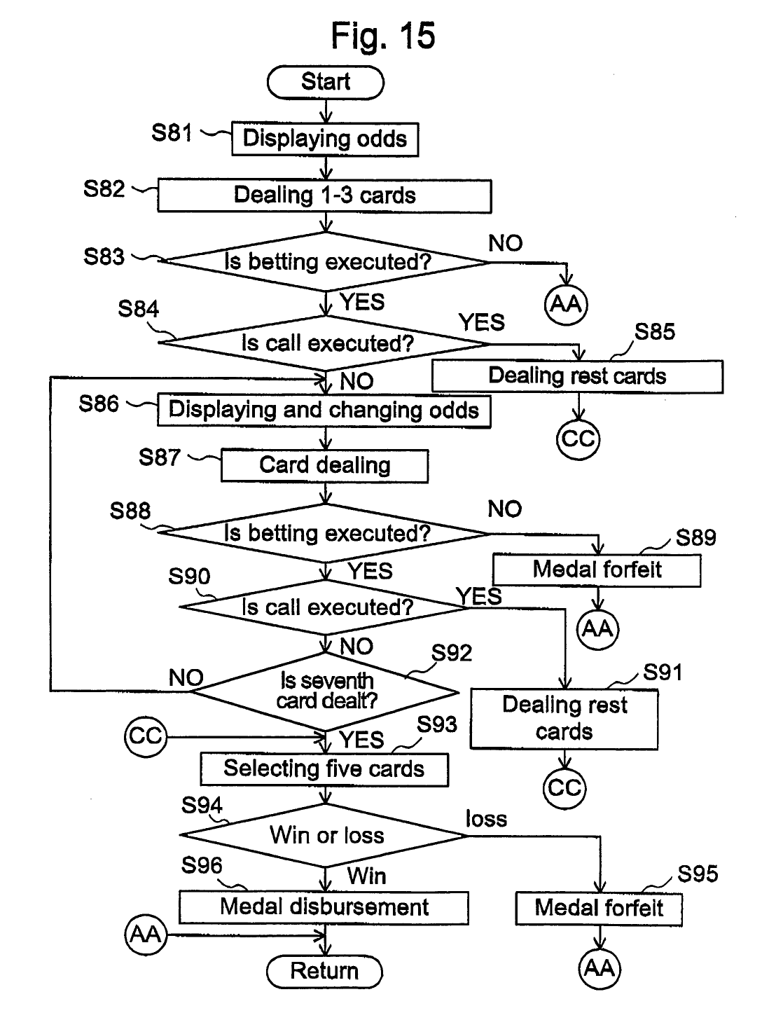

As shown in the flowchart of FIG. 15, the dealer displayed by the projector 30 in FIG. 12 first deals cards (Step S82). Lottery (or extraction) of cards to be dealt is similar to that shown in Embodiment 1. The first set of cards of respective players, which are dealt to the respective players, are displayed by the projector 30 and monitor screens 51 of the respective players (FIG. 12 and FIG. 13). Also, since the cards are displayed in a face down manner on the monitor screens 51 other than that of the player to whom the card is dealt, no player other than the player to whom a card is dealt knows the content of the card. Although the second set of cards are dealt to the respective players in a similar manner, since the cards are dealt, in a face down manner, to any player other than the respective player, the contents of the cards are not disclosed to any player other than the respective player. Although the third set of cards are dealt to the respective players in a similar manner, the cards are displayed by the projector 30 and monitor screens 51 with the faces thereof turned up. Therefore, any other players can see the contents of the cards. No cards dealt to the other players are displayed on the monitor screens 51 of the respective players. The cards of all of the players are arranged on the projector 30, and the third set of cards of the respective players, and the fourth, fifth and sixth set of cards thereof are displayed with the faces thereof turned up in accordance with the rules of “Seven Card Stud”, so that the contents of the cards are visible.

After the third set of cards are dealt, the respective players decide whether or not they will engage in betting (Step S83). The respective players determine, on the basis of the cards dealt in Step S31, whether or not they are engaged in betting or drop out of the game. When a player decides to place a bet, the process shifts to Step S84, and when a player decides to drop out of the game, the game of the player is over.

When betting is carried out, and the game is not continued due to a call (Step S84), the value of the odds is varied as in Embodiment 1 (Step S86). The value of the odds becomes a value of odds existing in the number of bets from the odds table located at the right upper part of FIG. 13, and the amount of repayment (fractions are rounded off) becomes a value which is obtained by multiplying the odds by the number of bets by the player. In order to receive the amount of repayment, it is necessary for the player to beat all the other players. The winning conditions are such that all the other players drop out of the game, or the player has a winning combination whose difficulty is highest (or a winning combination whose rank is highest, for example, a Royal Straight Flush can be made highest) in the player's own cards when the final call is made. If any one of the players makes a call (herein, regardless of respective amounts of betting) at the moment when the third set of cards are dealt, the remaining cards are sequentially dealt to the players (Step S85), and a player who made a call shows the his/her own cards and affirms his/her own winning hand, players other than the player show a better hand of cards (that is, cards that form a winning combination having a higher degree of difficulty or a higher rank) than the cards of the player who made the call, and they contrarily affirms his/her own winning hand. Herein, players who recognize a losing hand in the game need not disclose their own cards.

If the game advances to the next round without any call, the odds displayed in the allotment table on the monitor screens 51 are varied from the odds table in FIG. 13 to the odds table in FIG. 14 (Step S86). In detail, as shown in FIG. 14, there are winning combinations where the odds of a Straight become higher than the odds of a Royal Flush, or the odds are decreased as in a Two Pair if the number of bets is increased. After the process is terminated, the process shifts to the next step.

The fourth set of cards are dealt (Step S87), and are displayed by the projector 30 and monitor screens 51.

Next, the players decide whether or not they engage in the second round of betting (Step S88). As in Step S83, the players decide on the basis of the cards dealt in Step S87 whether or not they will continue further betting or drop out of the game. When betting is determined, the process shifts to Step S90, and when dropping-out is determined, the process shifts to Step S89.

When any one of the players decides to drop out of the game, the player is deprived of or has to forfeit the medals (Step S89). That is, the medals bet by the player are not disbursed to him/her, and the game is over.

When the betting is continued, this is similar to the case where the above-described third set of cards are dealt. The game shifts to the next round if no call is made (Step S90) and the cards are not the seventh set of cards (Step S92), wherein the odds displayed in the allotment table on the monitor screens 51, are varied (Step S86).

If no call is made (Step S90), the fifth, sixth and seventh set of cards are dealt as well. The seventh set of cards are displayed with the contents thereof disclosed to only the player as in the first and second set of cards in accordance with the rules of the game.

As described above, the betting intervals of five times are expired, and players, respectively, select five cards from the player's own seven cards for betting (Step S93). Selection of the five cards maybe carried out by players themselves or maybe selected by the gaming machine. Thus, the game is continued among the players who are still engaged in the game, wherein a player who discloses the his/her own cards or a player who has cards whose winning combination is higher than that of the disclosing player becomes the final winner of the poker game (Step S94). Also, other players who recognize a losing hand in the game need not disclose their own cards. Thus, players other than the final winner are deprived of or has to forfeit all the medals bet by them, and the amount of disbursement to the final winner is determined by multiplying his/her own number of bets by the odds decided on the fifth round of betting. For example, when player A has his/her own cards that form a Flush and player B has his/her own cards that form a Straight, player A who has a Flush becomes the winner, and player B is deprived of or has to forfeit the amount of his/her bet (for example, 13 medals/credit) (Step S95). Here, player A is able to receive an amount of disbursement of 66 medals (or credit), which are calculated by multiplying the amount of his/her bets (for example, 22 medals/credit) by the odds of 3.

As in Embodiment 1, disbursement of medals is carried out in accordance with the determined amount of disbursement (Step S96).

By carrying out the embodiment, the factor of winning or losing depends on the difficulty of a winning combination. However, the amount of disbursement does not depend on the difficulty of the winning combination. Therefore, while a large disbursement can be received when winning a game with a lower-ranked winning combination, there is a possibility that the amount of disbursement is slight even when winning a game with a higher-ranked winning combination. Accordingly, when a player considers that there is a possibility of winning a game with other players even if the player knows, during advancement of the game, that his/her own winning combination is lower-ranked, the player is able to continue the game while expecting that the amount of disbursement will increase, wherein players are able to further enjoy a game to its completion while experiencing a sense of thrill.

In addition, a player may intentionally raise the bet or stakes even if a lower-ranked winning combination is about to be formed, and cause hesitation in opposing players. Also, since players are able to experience various senses of thrill, the respective players can further enjoy the game.

### Embodiment 3

Next, as Embodiment 3, a description is given of an embodiment in which the present invention is applied to a poker gaming machine that is produced in advance for single player. Also, since the configuration of the control part of the poker gaming machine, and the image display apparatus thereof are the same as those of Embodiment 1, description thereof is herein omitted.

Configuration of Poker Gaming Machine

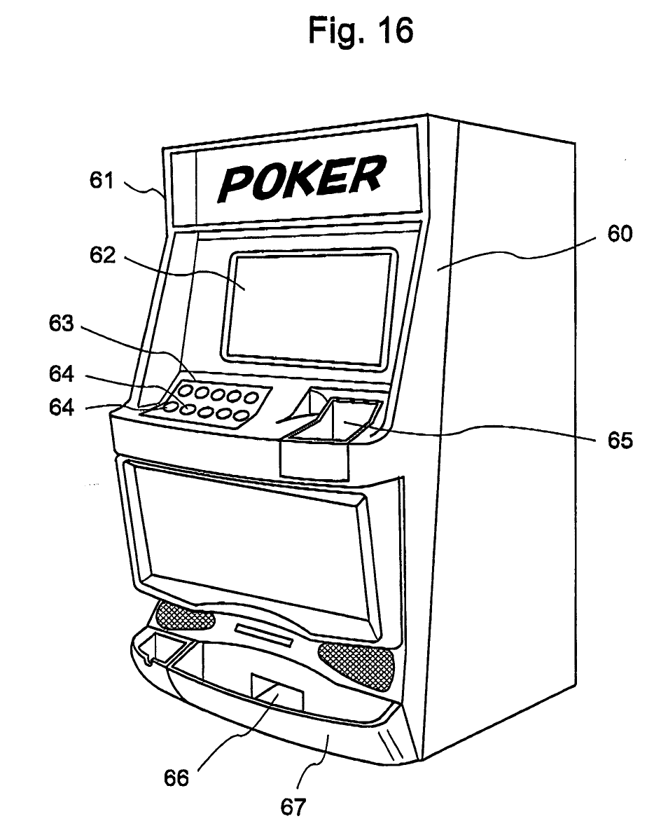

FIG. 16 is an elevation view showing the outline of a poker gaming machine 60 according to the invention. Also, in the embodiment described below, a case is shown where the invention is applied to a poker gaming machine as a preferred embodiment of the gaming machine according to the invention.

The gaming machine is produced for single player. The gaming machine includes a display panel 61, an image display device 62, a control panel 63, operation buttons 64, a medal slot 65, a medal ejection slot 66 and a medal receiving tray 67. The name, etc., of the machine is displayed on the display panel 61, and the image display device 62 displays images of a game. Operation buttons 64 for advancement of a game are disposed on the control panel 63.

Game in Poker Gaming Machine

Next, a detailed description is given of game procedures in the above-described poker gaming machine. Also, as described above, the game advancement procedure storing means composed of the ROM 4, etc., of the game control device 2 stores a plurality of patterns of game advancement procedures based on the strength or advantage of a virtual player, habits of game advancement, and profits obtained by a player, etc. In the respective embodiments, a game advancement procedure which is used for a game is extracted from the game advancement procedures.

Timing Chart

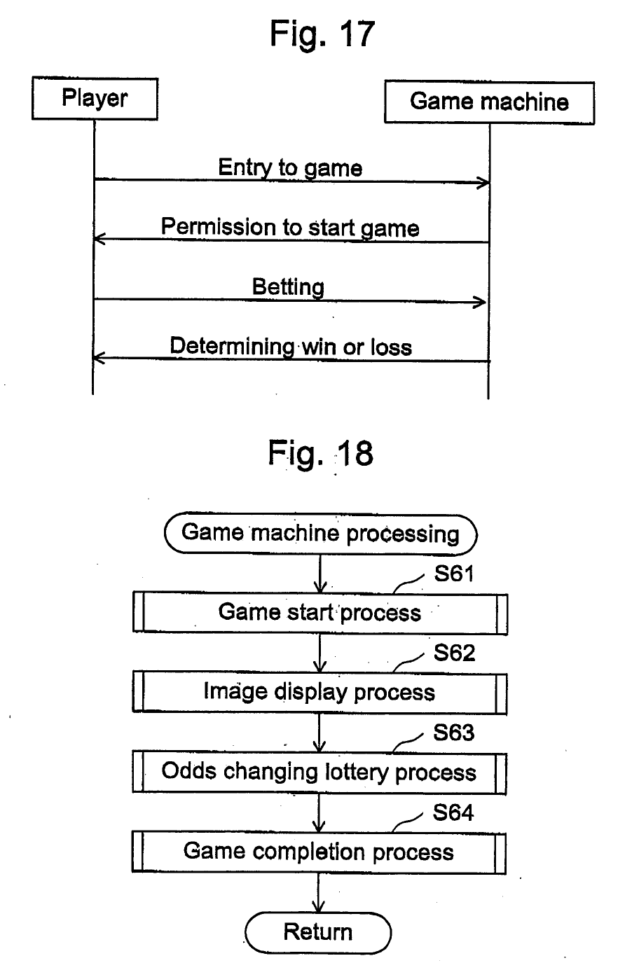

FIG. 17 is a timing chart showing an exchange of instructions between the player and the poker gaming machine 60.

First, a player makes an entry into a game. The player loads a medal into the medal slot 65 for entry. When a certain number of medals are loaded, the entry button can be pressed. If the player presses the entry button, the player receives a signal of making an entry.

Next, the poker gaming machine 60 transmits to a player, a signal of allowing the game. That is , the CPU 3 starts and creates a status in which the player can execute a game.

Next, the player executes betting. The player carries out betting to the poker gaming machine 60 in the betting interval. That is, the number of medals bet by the player is transmitted to the poker gaming machine 60.

Finally, winning or losing of the game is determined. The poker gaming machine 60 decides winning or losing of the game in accordance with the data stored in the ROM 4, and transmits the result of the game to the player.

Gaming Machine Processing

Next, a description is given of processes that are carried out inside the poker gaming machine. Also, as described above, the game advancement procedure storing means composed of the ROM 4, etc., of the game control device 2 stores a plurality of patterns of game advancement procedures based on the strength or advantage of a virtual player, habits of game advancement, and profits obtained by a player, etc. In the respective embodiments, a game advancement procedure which is used for a game is extracted from the game advancement procedures.

First, a game start process is executed in the poker gaming machine 1 as shown in FIG. 18 (Step S61). In Step S61, if a player loads medals, the medal sensor 12 detects the loaded medals, and the CPU 3 is informed that medals have been loaded. Then, the CPU 3 calls for game advancement procedures from the ROM 4, and the poker gaming machine 60 starts a game.

Next, an image display process is executed (step S62). In the process, the CPU 3 sets image data in a video RAM through the image display drive circuit 23, wherein the image data set in the video RAM are displayed on the image display device 62. After the process is terminated, the process shifts to Step S63.

Next, an odds changing lottery process is executed (Step S63). In the process, the CPU 3 causes the random number generator 10 to generate random numbers. Then, the random number sampling circuit 11 extracts an optional random number from the random numbers generated by the random number generator 10 and transmits it to the CPU 3. The CPU 3 records the random number in the RAM 5 as the lottery result. In addition, the process will be described later. After the process is terminated, the process shifts to Step S64.

Next, the game terminating process is executed (step S64). In the process, the CPU 3 decides winning or losing of the game in accordance with the game advancement procedures stored in the ROM 4. When the player wins the game, the CPU 3 sends the hopper drive circuit 20 an instruction for disbursing a prescribed number of medals, whereby medals are disbursed from the hopper 24. When the player loses the game, the process is immediately terminated after the winning or losing of the game is determined. After the process is terminated, the present subroutine is immediately terminated.

Odds Changing Lottery Process

As described above, a sub routine shown in FIG. 6 is called in the odds changing lottery process routine called in Step S13. The present sub routine is similar to that of Embodiment 1. Herein, the description thereof is omitted.

Game Procedure

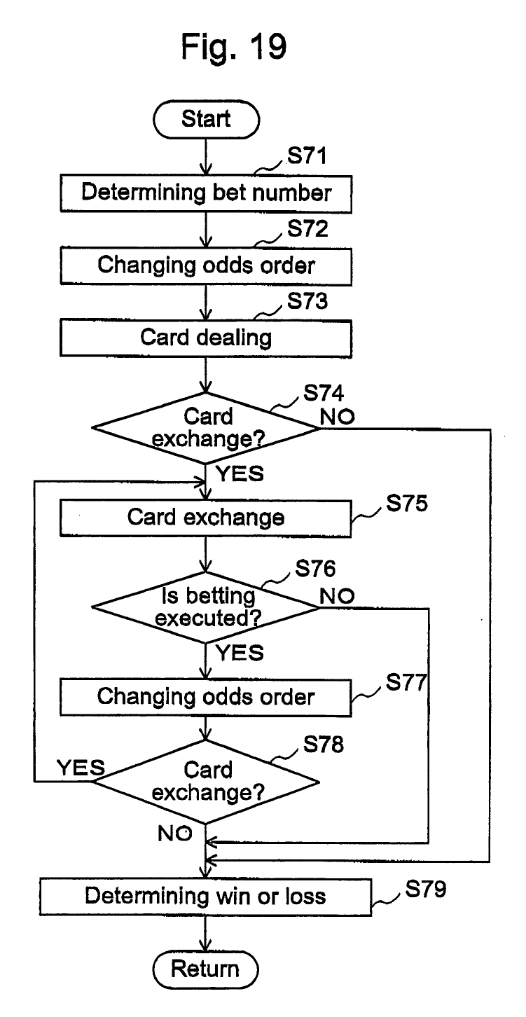

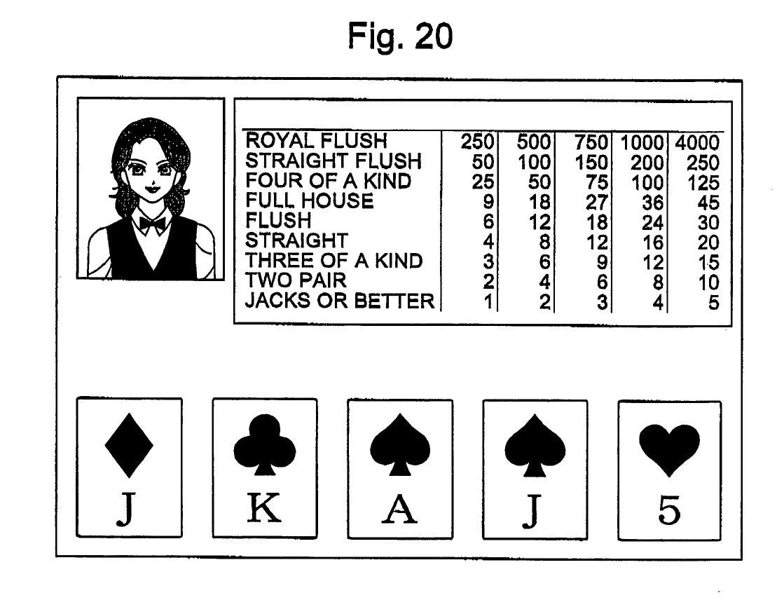

Next, FIG. 19 is a flowchart showing the game procedures.

First, a bet is determined (Step S71). A player decides how many medals are bet, and presses the decision button.

Next, the order of odds is varied (Step S72). When the CPU 3 receives an instruction about whether or not the betting is executed, it recognizes that the betting interval ends. And, the process of changing the order of odds is executed. Herein, as described above, when the CPU 3 provides an instruction of causing the random number generator 10 to generate random numbers, the random number sampling circuit 11 extracts an optional random number from the random numbers generated by the random number generator 10 and transmits it to the CPU 3. And, the CPU 3 records it in the RAM 5 as data indicating the lottery result. With regard to the data indicating the lottery result, the number of bets corresponding to a numerical value of eight digits is determined, for example, if the data are “12345678,” it corresponds to the number of bets 250, and the data are “22532013,” it corresponds to the number of bets 150. Therefore, the CPU 3 reads a numerical value of eight digits recorded in the RAM 5, the odds of respective winning combinations are determined. Then, the odds displayed in the allotment table on the monitor screen 51 are varied from those in FIG. 10 to those in FIG. 11. In detail, as shown in FIG. 11, winning combinations are brought about, in which the odds of a Straight become higher than the odds of a Royal Flush, or the odds are decreased, as in Two Pair, even if the number of bets is increased. After the process is terminated, the process shifts to Step S73.

Next, cards are dealt (Step S73). The CPU 3 transmits an instruction of determining the kind of card to the random number generator 10. The random number generator 10 executes a lottery to determine the kind of card.

The lottery data are composed of, for example, numerical values of two digits like “23,” and the numerical values per digit are, respectively, composed of ten numerical values from 0 through 9. The random number generator 10 that receives a random number generating instruction from the CPU 3 generates a random number, which becomes either one of numerical values from 0 through 9, two times per instruction. And, the random number is transmitted to the CPU 3 through the random number sampling circuit 11, and the CPU 3 transmits a signal indicating the numerical value of the random number to the RAM 5, and records the data of the respective random numbers in the RAM 5 as a card lottery result. The data are displayed by the projector 30 and monitor screen 51 as a card dealt to a player.

Next, it is determined whether or not the cards are exchanged (Step S74). A player judges, on the basis of the winning combination of the cards dealt in Step S73, whether or not the cards are exchanged. When the cards are exchanged, the process shifts to Step S75, and when no exchange is executed, the process shifts to Step S79.

Next, the cards are exchanged (Step S75). The player decides the cards that are desired to be exchanged, and cards that are desired to remain in his/her hand. And, the player presses the card exchange switch 17 secured below the card to be exchanged. The CPU 3 recognizes that the switch has been pressed, and provides an instruction of changing the image to the image display drive circuit 23, whereby a newly exchanged card is shown on the image display device 62. After the process is terminated, the process shifts to Step S76.

Next, a player decides whether or not he/she executes betting (Step S76). The player decides, based on the result of having exchanged the card in Step S75, whether or not he/she executes betting. When betting is determined, the process shifts to Step S77, and when no betting is performed, the process shifts to Step S79.

When the player decides that betting will be performed, the order of odds is varied (Step S77). The CPU 3 carries out a process of changing the order of odds by the method similar to that in Step S72. After the process is terminated, the process shifts to Step S78.

Next, it is determined whether or not the cards are exchanged (Step S78). A player judges, on the basis of the result in Step S78, whether or not the cards are exchanged. When the cards are exchanged, the process shifts to Step S75, and the above-described process is repeated, wherein since the odds are varied whenever the player executes betting, the amount of disbursement is not necessarily increased even if the number of bets is increased. Therefore, the player can enjoy the sense of thrill similar to bluffing. When no exchange is performed, the process shifts to Step S79.

When no card is exchanged in Step S78, winning or losing of the game is determined (Step S79). The CPU 3 compares the winning combination of the cards exchanged in Step S75 with the winning combination of the dealer in the allotment data stored in the ROM 4 and determines the winning or losing. The hopper 24 for depositing and reserving game medals is connected to the hopper drive circuit 20. The CPU 3 judges the final winning combination of the player and the winning combination of the player is ranked higher than that of the dealer, the final number of bets corresponding to the winning combination is used for multiplication. And, the numerical value is transmitted to the hopper drive circuit 20. The hopper drive circuit 20 operates for the hopper 24 which disburses some from the game medals deposited and reserved therein.

By carrying out the embodiment, the factor of winning or losing does not depend on the difficulty in formation of winning combinations. Therefore, there is a possibility to win a game even with a lower-ranked winning combination, wherein winning or losing cannot be foreseen until the end. For this reason, a player is able to enjoy a game until its completion while experiencing the sense of thrill without giving up the game even if the player recognizes during advancement of the game, that his/her own winning combination is lower-ranked.

In addition, when a plurality of players enjoy a game, a player may intentionally raise the bet or stakes even if a lower-ranked winning combination is about to be formed, and cause hesitation in the opposing players. However, since such bluffing or tactics is not employed when playing a game with a gaming machine for single player, there is a problem in lacking experience of the sense of thrill. By carrying out the invention, since the order of odds may be varied whenever executing a betting, and a procedure of exchanging cards is repeated, the player experiences a sense of thrill similar to enjoying bluffing whenever exchanging the cards.

In addition, in the embodiments described above, although a poker gaming machine is employed, the present invention is not limited thereto. The gaming machine may include gaming machines in which winning combinations are established and odds are set in response to the winning combinations, such as a Japanese flower card gaming machine, mahjong gaming machine, etc.

Also, in the above-described embodiments, although odds are varied by executing a lottery for each of the winning combinations in the process of changing the odds, the invention is not limited thereto, wherein the odds may be varied by preparing several types of tables in which winning combinations and odds corresponding thereto are determined in advance and determining one of the tables through lottery.

Though the above-described embodiment is arranged from just gaming machine 1, an arrangement in which a server 80 is connected with gaming machines 1 as terminal devices as shown in FIG. 21 is also possible. Specifically, server 80 maybe arranged to make the terminal device gaming machines 1 display dealer images, card images, etc., based on operations of players at the terminal device gaming machines 1 and thereby make a game proceed.

According to the invention, since “with respect to winning combinations included in the above-described plurality of winning combinations, the above-described number-of-disbursement determining means determines whether the above-described number of disbursements is increased or decreased, or the number of disbursements is maintained,” a gambling feature is brought about in the betting itself, wherein it is possible to amplify the sense of thrill of a player.

What is claimed is:

1. A gaming machine with which a combination-making game is performed, the combination-making game comprising a plurality of winning combinations, wherein a disbursement number is determined for each winning combination, the gaming machine being characterized in paying out as many game media as obtained by multiplying a corresponding disburse number and a bet number a player bet when the corresponding winning combination is formed, the gaming machine comprising:
an operating means for allowing the player to conduct an operation to increase the bet number;
a detecting means for detecting the operation through said operating means;
a disbursement number change means for changing each disbursement number so that an amount order of disbursements by the gaming machine is changed as said detecting means detects the operation; and
a determining means for determining each disbursement number for a respective winning combination.

2. The gaming machine according to claim 1, wherein said operating means becomes operative when the player loads game media, or for a predetermined number of times or for a predetermined period of time during the combination-making game that is carried out in the gaming machine.

3. The gaming machine according to claim 1, wherein said determining means determines whether increasing, decreasing, or maintaining said each disbursement number for the respective winning combination.

4. The gaming machine according to claim 2, wherein said determining means determines whether increasing, decreasing, or maintaining said each disbursement number for the respective winning combination.

5. A gaming machine with which a combination-making game is performed, the combination-making game comprising collecting a predetermined number of dealt elements so as to make at least one of wining combinations with respectively different ranks; and determining win/loss of the combination-making game based on a corresponding rank, the gaming machine comprising:
a bet operating means for allowing a player to conduct an operation to bet game media;
a drop operating means for allowing the player to drop the combination-making game;
an operation detecting means for detecting that said bet operating means or said drop operating means is operated;
a disbursement multiplication factor changing means for determining a multiplication factor of disbursement by a lottery independently from the respective rank having previously been allocated to each wining combination as said operation detecting means detects; and
a disbursement number determining means for collecting game media bet by a dropped player and determining a disbursement number obtained from a bet number of game media a winning player bet and the multiplication factor of disbursement.

6. The gaming machine according to claim 5, wherein the combination-making game is played by a plurality of players including a dealer set by the gaming machine.

7. The gaming machine according to claim 5, wherein said gaming machine comprises:
a server being composed of said disbursement multiplication factor changing means and said disbursement number determining means;
a game terminal being composed of said bet operating means, said drop operating means, and said operation detecting means; and
a communications means including a communications line for connecting said server to said game terminal.

8. A server for controlling a gaming machine with which a combination-making game is performed, the combination-making game comprising a plurality of winning combinations, wherein a disbursement number is determined for each winning combination, the gaming machine being characterized in paying out as many game media as obtained by multiplying a corresponding disburse number and a bet number a player bet when a corresponding winning combination is formed, the server comprising:
an operation detecting means for detecting that the player operates to increase said bet number;
a disbursement multiplication factor changing means for changing each disbursement number so that an amount order of disbursements by the gaming machine is changed as said operation detecting means detects an operation; and
a disbursement number determining means for determining each disbursement number for each winning combination.

9. A program in which a combination-making game is performed, the combination-making game comprising a plurality of winning combinations, wherein a disbursement number is determined for each winning combination, the gaming machine being characterized in paying out as many game media as obtained by multiplying a corresponding disburse number and a bet number a player bet when a corresponding winning combination is formed, the program comprising:
detecting that the player operates to increase said bet number;
changing each disbursement number so that an amount order of disbursements by the gaming machine is changed as the detecting means detects an operation of the player; and
determining each disbursement number for each winning combination.
